(19) United States
(12) Patent Application Publication
(10) Pub. No.: US 2025/0278928 A1
(43) Pub. Date: Sep. 4, 2025

(54) FILTERING IMAGE-TEXT DATA USING A FINE-TUNED MACHINE LEARNING MODEL

(71) Applicant: Lemon Inc., Grand Cayman (KY)

(72) Inventors: Linjie Yang, Los Angeles, CA (US); Weizhi Wang, Los Angeles, CA (US); Khalil Mrini, Los Angeles, CA (US); Sateesh Kumar, Los Angeles, CA (US); Heng Wang, Los Angeles, CA (US)

(21) Appl. No.: 18/792,516

(22) Filed: Aug. 1, 2024

Related U.S. Application Data
(60) Provisional application No. 63/559,589, filed on Feb. 29, 2024.

(51) Int. Cl. G06V 10/776; G06V 10/778

(52) U.S. Cl. CPC G06V 10/776; G06V 10/7784

(57) ABSTRACT

The present disclosure describes techniques for filtering image-text data. Instruction data is constructed on a plurality of image-text pair quality scoring tasks. A machine learning model is fine-tuned to an image-text data filter using the constructed instruction data. A quality of each image-text pair from a dataset is evaluated by the fine-tuned machine learning model using a plurality of metrics. The plurality of metrics comprises an Image-Text Matching (ITM) metric, an Object Detail Fulfillment (ODF) metric, and a Caption Text Quality (CTQ) metric. High-quality image-text pairs are selected from the dataset based on one or more of the plurality of metrics.

### CROSS-REFERENCE TO RELATED APPLICATION

The present disclosure claims priority to the U.S. Provisional Application No. 63/559,589, filed on Feb. 29, 2024, which is incorporated herein by reference in its entirety.

### BACKGROUND

Machine learning models are increasingly being used across a variety of industries to perform a variety of different tasks. Such tasks may include data filtering. Improved techniques for utilizing machine learning models for data filtering are desirable.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1A shows an example system for fine-tuning a machine learning model to an image-text data filter in accordance with the present disclosure.

FIG. 1B shows an example system for filtering image-text data using a fine-tuned machine learning model in accordance with the present disclosure.

FIG. 2 shows an example system for filtering image-text data using a fine-tuned machine learning model in accordance with the present disclosure.

FIG. 3A shows an example image-text matching score distribution before rebalancing in accordance with the present disclosure.

FIG. 3B shows an example image-text matching score distribution after rebalancing in accordance with the present disclosure.

FIG. 4 shows an example system for generating instruction data in accordance with the present disclosure.

FIG. 5 shows an example process for filtering image-text data in accordance with the present disclosure.

FIG. 6 shows an example process for training a machine learning model using filtered image-text data in accordance with the present disclosure.

FIG. 7 shows an example process for fine-tuning a machine learning model to an image-text data filter in accordance with the present disclosure.

FIG. 8 shows an example process for generating instruction data in accordance with the present disclosure.

FIG. 9 shows an example process for filtering image-text data in accordance with the present disclosure.

FIG. 10 shows an example table illustrating ablation results in accordance with the present disclosure.

FIG. 11 shows an example table illustrating performance data in accordance with the present disclosure.

FIG. 12 shows an example table illustrating performance data in accordance with the present disclosure.

FIG. 13A shows an example table illustrating performance data in accordance with the present disclosure.

FIG. 13B shows an example table illustrating score data in accordance with the present disclosure.

FIG. 14 shows an example computing device which may be used to perform any of the techniques disclosed herein.

### DETAILED DESCRIPTION OF ILLUSTRATIVE EMBODIMENTS

Image-text datasets have been the major driving force for the recent breakthrough in Vision-Language Models (VLMs) and Text-to-Image generation models. Such image-text datasets can be used to train or fine-tune these foundation models. The ever-growing size of such datasets allows researchers to scale the models to unprecedented capacities with billions or even trillions of parameters. These foundation models lead to significant improvements in many down-stream tasks, such as image classification, text-to-image retrieval, image captioning, visual question answering, image generation and editing, etc. The quality of the image-text data in the image-text datasets greatly impacts the final performance of the foundation models trained or fine-tuned using the image-text datasets. However, web-crawled image-text data is often very noisy (e.g., the corresponding text data has low quality or does not match the content of the image).

Described herein are improved techniques for filtering image-text data effectively and efficiently. The techniques described herein leverage a teacher MLM to construct high-quality instruction tuning data for effectiveness. The high-quality instruction tuning data can be used to fine-tune a more accessible MLM for filtering image-text data for efficiency.

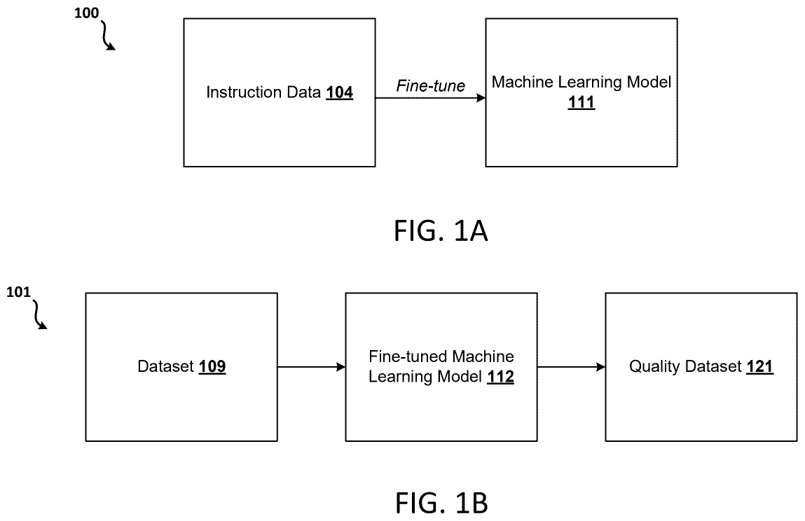

FIG. 1A illustrates an example system 100 in accordance with the present disclosure. The system 100 may be used for fine-tuning a machine learning model 111. The machine learning model 111 can be fine-tuned on instruction data 104. The instruction data 104 can be constructed by (e.g., generated by) a teacher Multimodal Language Model (MLM). The teacher MLM can generate the instruction data 104 corresponding to a plurality of image-text pair quality scoring tasks. The plurality of image-text pair quality scoring tasks can include Image-Text Matching (ITM) scoring task, an Object Detail Fulfillment (ODF) scoring task, and a Caption Text Quality (CTQ) scoring task. The ITM scoring task can be configured to evaluate whether a text in an image-text pair accurately represents primary features of an image in the image-text pair. The ODF scoring task can be configured to evaluate whether the text depicts detailed properties of objects in the image. The CTQ scoring task can be configured to evaluate a quality of the text based on a grammatical correctness, diversity of vocabulary, fluency, readability, length, and structure of the text.

An image-text pair and a description of one of the plurality of image-text pair quality scoring tasks can be input to the teacher MLM. The teacher MLM can be prompted to first generate a score of the image-text pair for the particular quality scoring task and to subsequently generate an explanation for the score. This process can be repeated for each of the plurality of image-text pair quality scoring tasks. The instruction data 104 can include the generated score(s) and the corresponding explanation(s).

The machine learning model 111 that has been fine-tuned on the instruction data 104 can be referred to as the fine-tuned machine learning model 112 (shown in FIG. 1B). The fine-tuned machine learning model 112 can serve as an image-text data filter. As shown in the system 101 of FIG. 1B, a dataset 109 can be input into the fine-tuned machine learning model 112. The dataset 109 can include a plurality of image-text pairs. Each image-text pair can include an image and a caption corresponding to the image. The fine-tuned machine learning model 112 can receive the dataset 109. The fine-tuned machine learning model 112 can filter the dataset to obtain the quality dataset 121 based on (e.g., using) a plurality of metrics. The plurality of metrics can include an ITM metric, an ODF metric, and a CTQ metric.

The quality dataset 121 can be obtained based on at least one score for each of the image-text pairs in the dataset 109. For example, the at least one score can include one or more of an ITM score (e.g., a score indicative of an ITM quality level of each image-text pair), an ODF score (e.g., a score indicative of an ODF quality level of each image-text pair), and a CTQ score (e.g., a score indicative of a CTQ quality level of each image-text pair) for each of the image-text pairs in the dataset 109. The quality dataset 121 can comprise high-quality image-text pairs. The high-quality image-text pairs can be used to train or fine-tune a downstream machine learning model. The downstream machine learning model can include an image classification model, a text-to-image retrieval model, an image captioning model, a visual question answering model, an image generation and/or editing model, and/or any other type of machine learning model.

The pipeline for filtering data to select high-quality image-text pairs and utilizing the selected high-quality image-text pairs may involve three stages. The first stage involves constructing multimodal instruction tuning data on proposed quality scoring tasks. The second stage involves fine-tuning a machine learning model (e.g., the machine learning model 111) to achieve accurate quality assessments using the multimodal instruction tuning data. The third stage involves training downstream machine learning models, such as VLMs, using the filtered dataset and evaluating the trained downstream machine learning models on downstream tasks to demonstrate the effectiveness of the proposed filtering techniques.

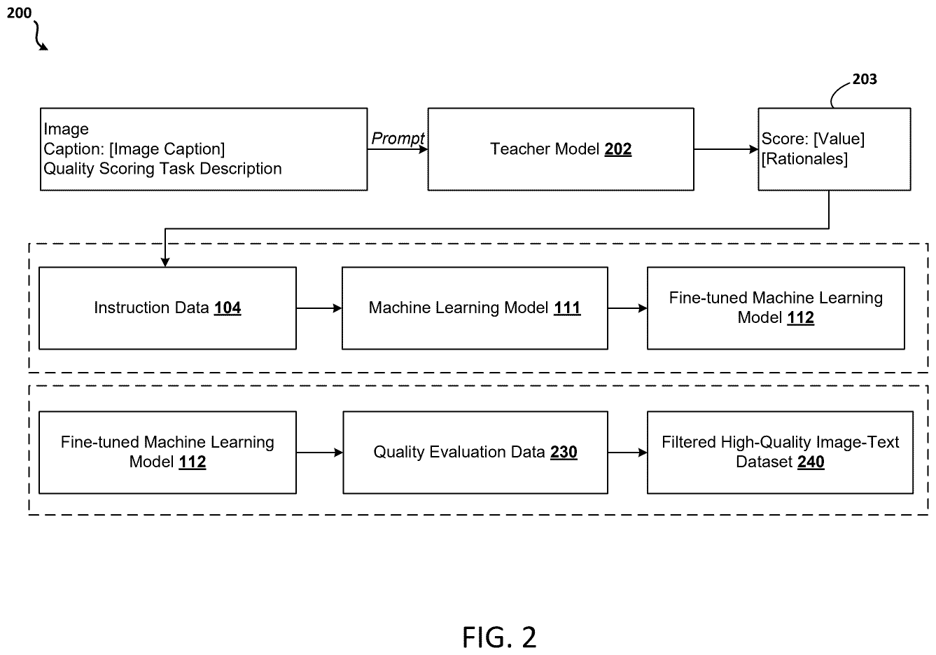

The first two stages of the pipeline are shown in the system 200 of FIG. 2. In order for the machine learning model 111 to work as an effective data filter, the machine learning model 111 can be fine-tuned to generate quality scores for image-text pairs. The quality scores can be used for data selection and filtering. The machine learning model 111 can be fine-tuned on a set of scoring tasks to enhance the scoring capability of the machine learning model 111.

The machine learning model 111 can be fine-tuned on a plurality of image-text pair quality scoring tasks. The plurality of image-text pair quality scoring tasks can include an Image-Text Matching (ITM) scoring task, an Object Detail Fulfillment (ODF) scoring task, and a Caption Text Quality (CTQ) scoring task. The fine-tuned machine learning model 112 can thereby evaluate the quality of image-text pairs from multiple perspectives (e.g., using a plurality of different quality evaluation metrics on a scale of 0-100). The plurality of different quality evaluation metrics can include an ITM metric. The ITM metric focuses on evaluating whether the caption in each image-text pair accurately represents the main features and objects of the image and captures its primary theme of the image in each image-text pair.

The plurality of different quality evaluation metrics can also include an ODF metric. The ODF metric focuses on evaluating whether the caption in each image-text pair provides detailed descriptions of objects that align with the image in each image-text pair. Specifically, ODF assesses if the caption sufficiently describes the properties of the objects in the image, e.g., number, color, size, position, shape, etc. Compared with the ITM metric, the ODF metric focuses more on the fine-grained alignment between the detailed object properties in the image and the ones described in the corresponding caption.

The plurality of different quality evaluation metrics can further include a CTQ metric. The CTQ metric focuses on evaluating the text quality of caption in each image-text pair based on the grammatical correctness, diversity of vocabulary (e.g., the range and uniqueness of words), fluency (e.g., smoothness and natural flow of sentences), readability, length, and structure of the caption in each image-text pair.

The multimodal instruction tuning data needed to fine-tune the machine learning model 111 on the set of scoring tasks can be difficult and expensive to collect manually (e.g., via human labeling). Thus, in embodiments in accordance with the present disclosure, a teacher model 202 can be leveraged to construct the multimodal instruction data for scoring tasks. The teacher model 202 can be prompted to construct the multimodal instruction data for the plurality of image-text pair quality scoring tasks. Prompting the teacher model 202 to construct the multimodal instruction data for the plurality of image-text pair quality scoring tasks can include inputting an image, a text caption corresponding to the image, and a description of a particular image-text pair quality scoring task among a plurality of image-text pair quality scoring tasks into the teacher model 202.

In embodiments, to prompt the teacher model 202 to construct multimodal instruction data for the ITM scoring task, the prompt can include the following description: “Please evaluate if the provided text caption accurately represents the main features and objects of the image. The caption does not need to detail every aspect of the image, but it should capture its primary theme. Rate the overall quality of the text caption's match to the image on a scale of 1-100, considering the criteria mentioned.”

In embodiments, to prompt the teacher model 202 to construct multimodal instruction data for the ODF scoring task, the prompt can include the following description: “Please evaluate the text caption to determine if it provides detailed descriptions of objects that align with the image description. Specifically, assess if the caption sufficiently describes the color, size, position, shape, material, etc., of the objects. Afterward, rate the caption's overall accuracy in capturing object details from the image on a scale of 1-100, based on the criteria provided.”

In embodiments, to prompt the teacher model 202 to construct multimodal instruction data for the CTQ scoring task, the prompt can include the following description: “Please evaluate the text caption based on the following criteria: Grammatical Correctness, Diversity of Vocabulary (e.g., the range and uniqueness of words used), Fluency (e.g., smoothness and natural flow of sentences), Readability, Length, and Structure. Assign an overall quality score on a scale of 1-100.”

In embodiments, the prompt can further prompt the teacher model 202 to generate a scoring explanation. Prompting the teacher model 202 to generate a scoring explanation can help to ensure the reasoning accuracy of the fine-tuned multimodal language model 112. The scoring explanation can include a Chain-of-Thought (CoT) reasoning. For example, the prompt can include the following instruction: “Please think step by step to first output your reasons to give such a score. In the subsequent line, please output a single line containing the value indicating the scores.” The scoring explanation can include a rationalization reasoning. For example, the prompt can include the following instruction: “Please first output a single line containing the value indicating the scores. In the subsequent line, please provide a comprehensive explanation of your evaluation, avoiding any potential bias.”

The rationalization reasoning can be preferably adopted between these two prompting strategies. Computational efficiency is a concern as billions of image-text pairs may be evaluated by a fine-tuned machine learning model. If the machine learning model is fine-tuned to output score value first, the model's text generation process can be stopped early in the inference stage as only a single score value token may be needed for filtering data. The experimental results also demonstrate that instruction tuning with the rationalization reasoning leads to better performance than adopting the CoT reasoning.

Based on the prompt, the teacher model 202 can generate an output 203. The output 203 can include a score of an image-text pair for the particular image-text pair quality scoring task. The output 203 can include the scoring explanation (e.g., a CoT reasoning and/or a rationalization reasoning). The output 203 can be used to generate the instruction data 104. The instruction data 104 may be input into the machine learning model 111 to fine-tune the machine learning model 111 (e.g., to generate the fine-tuned machine learning model 112).

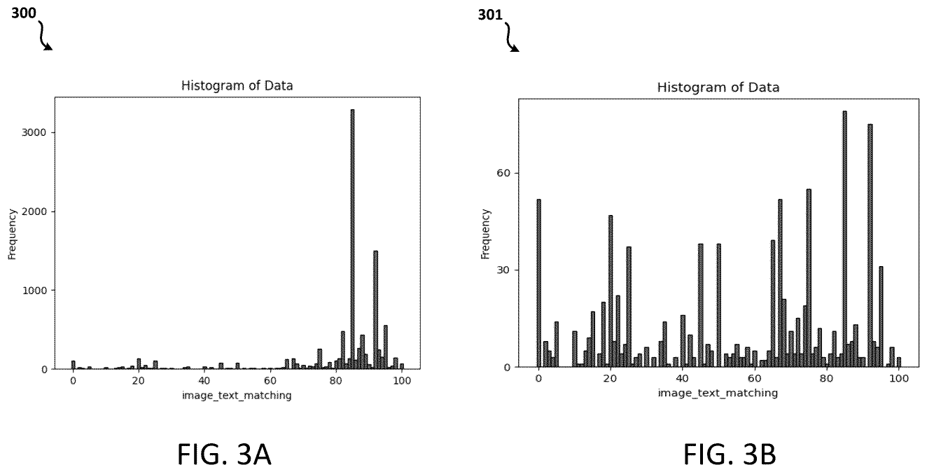

In embodiments, the instruction data 104 used for fine-tuning should contain image-text pairs of varying quality. Data diversity can be essential to enhance the fine-tuned machine learning model 112, enabling it to effectively score image-text data across all quality levels. If the initial instruction data generated by teacher model 202 is not uniformly distributed on the score scale of 100 (e.g., see the histogram 300 of FIG. 3A), the initial instruction data can be sampled into a balanced instruction set (e.g., see the histogram 301 of FIG. 3B) to avoid the learning bias from the unbalanced score distribution. To sample the initial instruction data into a balanced instruction set, the initial instruction data can be grouped into ten buckets and 100 instructions can be uniformly sampled from each bucket. The score distribution of the balanced instruction set can be more diverse and uniform than the original score distribution. The balanced instruction set for all three metrics can be combined into a single balanced instruction data set for fine-tuning the machine learning model 111, enabling the fine-tuned machine learning model 112 to generate three proposed quality metrics given different metric generation prompts.

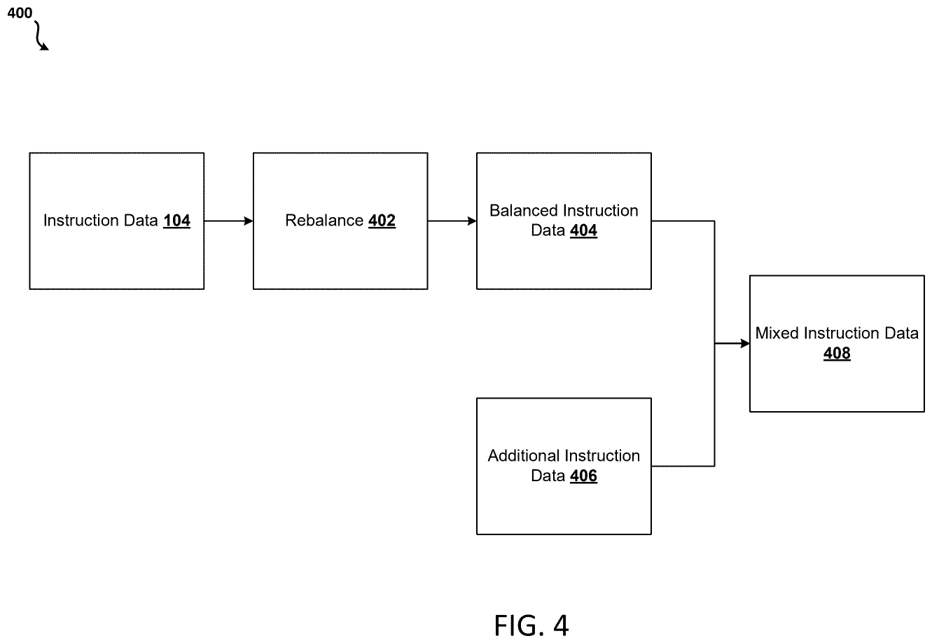

In embodiments, the balanced instruction data set can be combined (e.g., mixed) with additional instruction data to generate the final instruction data used to fine-tune the machine learning model 111. FIG. 4 shows a process 400 for generating the final instruction data used to fine-tune the machine learning model 111. As described above, the initial instruction data 104 generated by the teacher model 202 can be rebalanced (e.g., at 402) to generate balanced instruction data 404. To rebalance the initial instruction data 104 into the balanced instruction data 404, the initial instruction data 104 can be grouped into ten buckets and 100 instructions can be uniformly sampled from each bucket. The score distribution of the balanced instruction data 404 can be more diverse and uniform than the original score distribution. The balanced instruction data 404 can be combined (e.g., mixed) with additional instruction data 406 to generate mixed instruction data 408. The additional instruction data 406 can include instruction data related to a variety of vision-language tasks, such as captioning, OCR, visual question-answering, etc. The machine learning model 111 can be fine-tuned on the mixed instruction data 408 to generate the fine-tuned machine learning model 112.

Referring back to FIG. 2, the fine-tuned machine learning model 112 can generate quality evaluation data 230. The fine-tuned machine learning model 112 can generate the quality evaluation data 230 based on evaluating a quality of each image-text pair from a dataset (e.g., the dataset 109) using the plurality of metrics (e.g., the ITM metric, the ODF metric, and/or the CTQ metric). Evaluating the quality of each image-text pair from the dataset can include generating a first score indicative of an ITM quality level of each image-text pair. Evaluating the quality of each image-text pair from the dataset can include generating a second score indicative of an ODF quality level of each image-text pair. Evaluating the quality of each image-text pair from the dataset can include generating a third score indicative of a CTQ quality level of each image-text pair.

In embodiments, high-quality image-text pairs from the dataset can be selected based on one or more of the plurality of metrics. Selecting high-quality image-text pairs from the dataset based on one or more of the plurality of metrics can include selecting the high-quality image-text pairs from the dataset based on at least one of the first score, a second score, or a third score of each image-text pair. The selected high-quality image-text pairs can form a filtered high-quality image-text dataset 240. The filtered high-quality image-text dataset 240 can be used to train a different machine learning model. The different machine learning model can include an image classification model, a text-to-image retrieval model, an image captioning model, a visual question answering model, an image generation and/or editing model, and/or any other type of machine learning model.

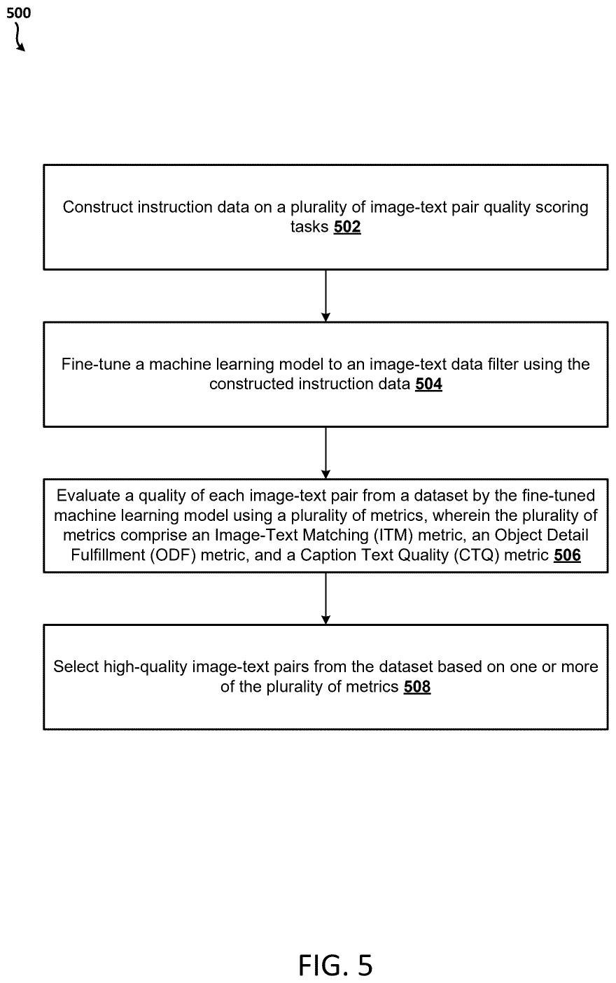

FIG. 5 shows an example process 500 for filtering image-text data. Although depicted as a sequence of operations in FIG. 5, those of ordinary skill in the art will appreciate that various embodiments may add, remove, reorder, or modify the depicted operations.

At 502, instruction data (e.g., instruction data 104) can be constructed. The instruction data be constructed on a plurality of image-text pair quality scoring tasks. The plurality of image-text pair quality scoring tasks can include Image-Text Matching (ITM) scoring task, an Object Detail Fulfillment (ODF) scoring task, and a Caption Text Quality (CTQ) scoring task. The ITM scoring task can be configured to evaluate whether a text in an image-text pair accurately represents primary features of an image in the image-text pair. The ODF scoring task can be configured to evaluate whether the text depicts detailed properties of objects in the image. The CTQ scoring task can be configured to evaluate a quality of the text based on a grammatical correctness, diversity of vocabulary, fluency, readability, length, and structure of the text. The instruction data can indicate a score of each image-text pair for each of the plurality of image-text pair quality scoring tasks.

At 504, a machine learning model (e.g., machine learning model 111) can be fine-tuned to an image-text data filter. The machine learning model can be fine-tuned to the image-text data filter using the constructed instruction data. The fine-tuned machine learning model can evaluate the quality of image-text pairs from multiple perspectives (e.g., using three different quality evaluation metrics on a scale of 0-100). At 506, a quality of each image-text pair from a dataset (e.g., dataset 109) can be evaluated. The quality of each image-text pair from the dataset can be evaluated by the fine-tuned machine learning model (e.g., fine-tuned machine learning model 112). The quality of each image-text pair from the dataset can be evaluated using a plurality of metrics. The plurality of metrics can include an Image-Text Matching (ITM) metric, an Object Detail Fulfillment (ODF) metric, and a Caption Text Quality (CTQ) metric.

At 508, high-quality image-text pairs (e.g., filtered high-quality image-text dataset 240) can be selected from the dataset. The high-quality image-text pairs can be selected from the dataset based on one or more of the plurality of metrics. Selecting high-quality image-text pairs from the dataset based on one or more of the plurality of metrics can include selecting the high-quality image-text pairs from the dataset based on a score associated with at least one of the plurality of metrics. For example, selecting high-quality image-text pairs from the dataset based on a score associated with at least one of the plurality of metrics can include selecting image-text pairs having a score associated with at least one of the plurality of metrics that satisfies (e.g., exceeds) a threshold.

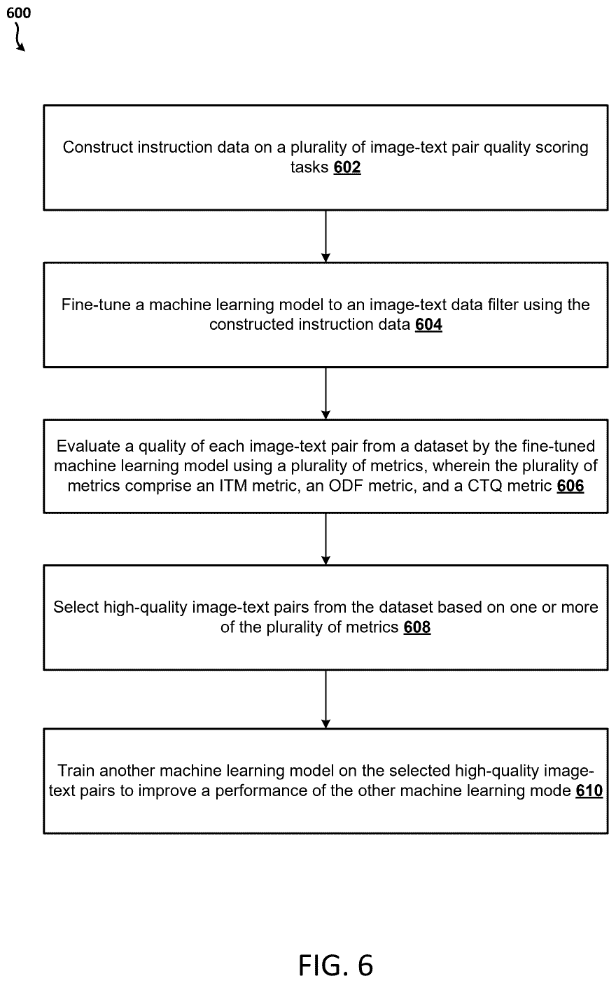

FIG. 6 shows an example process 600 for training a machine learning model using filtered image-text data. Although depicted as a sequence of operations in FIG. 6, those of ordinary skill in the art will appreciate that various embodiments may add, remove, reorder, or modify the depicted operations.

At 602, instruction data (e.g., instruction data 104) can be constructed. The instruction data be constructed on a plurality of image-text pair quality scoring tasks. The plurality of image-text pair quality scoring tasks can include Image-Text Matching (ITM) scoring task, an Object Detail Fulfillment (ODF) scoring task, and a Caption Text Quality (CTQ) scoring task. The ITM scoring task can be configured to evaluate whether a text in an image-text pair accurately represents primary features of an image in the image-text pair. The ODF scoring task can be configured to evaluate whether the text depicts detailed properties of objects in the image. The CTQ scoring task can be configured to evaluate a quality of the text based on a grammatical correctness, diversity of vocabulary, fluency, readability, length, and structure of the text. The instruction data can indicate a score of each image-text pair for each of the plurality of image-text pair quality scoring tasks.

At 604, a machine learning model (e.g., machine learning model 111) can be fine-tuned to an image-text data filter. The machine learning model can be fine-tuned to the image-text data filter using the constructed instruction data. The fine-tuned machine learning model can evaluate the quality of image-text pairs from multiple perspectives (e.g., using three different quality evaluation metrics on a scale of 0-100). At 606, a quality of each image-text pair from a dataset (e.g., dataset 109) can be evaluated. The quality of each image-text pair from the dataset can be evaluated by the fine-tuned machine learning model (e.g., fine-tuned machine learning model 112). The quality of each image-text pair from the dataset can be evaluated using a plurality of metrics. The plurality of metrics can include an Image-Text Matching (ITM) metric, an Object Detail Fulfillment (ODF) metric, and a Caption Text Quality (CTQ) metric.

At 608, high-quality image-text pairs (e.g., filtered high-quality image-text dataset 240) can be selected from the dataset. The high-quality image-text pairs can be selected from the dataset based on one or more of the plurality of metrics. Selecting high-quality image-text pairs from the dataset based on one or more of the plurality of metrics can include selecting the high-quality image-text pairs from the dataset based on a score associated with at least one of the plurality of metrics. For example, selecting high-quality image-text pairs from the dataset based on a score associated with at least one of the plurality of metrics can include selecting image-text pairs having a score associated with at least one of the plurality of metrics that satisfies (e.g., exceeds) a threshold.

At 610, another machine learning model can be trained on the selected high-quality image-text pairs. Training the other machine learning model on the selected high-quality image-text pairs can improve a performance of the other machine learning model. The other machine learning model can include an image classification model, a text-to-image retrieval model, an image captioning model, a visual question answering model, an image generation and/or editing model, and/or any other type of machine learning model.

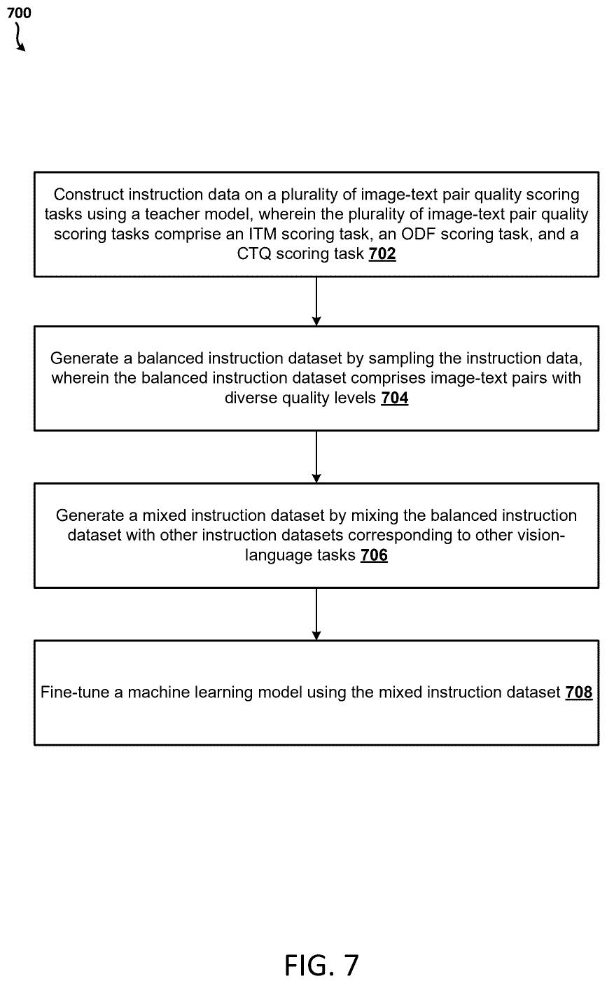

FIG. 7 shows an example process 700 for fine-tuning a machine learning model to an image-text data filter. Although depicted as a sequence of operations in FIG. 7, those of ordinary skill in the art will appreciate that various embodiments may add, remove, reorder, or modify the depicted operations.

At 702, instruction data (e.g., instruction data 104) can be constructed using a teacher model (e.g., teacher model 202). The teacher model can construct the instruction data on a plurality of image-text pair quality scoring tasks. The plurality of image-text pair quality scoring tasks can include Image-Text Matching (ITM) scoring task, an Object Detail Fulfillment (ODF) scoring task, and a Caption Text Quality (CTQ) scoring task. The ITM scoring task can be configured to evaluate whether a text in an image-text pair accurately represents primary features of an image in the image-text pair. The ODF scoring task can be configured to evaluate whether the text depicts detailed properties of objects in the image. The CTQ scoring task can be configured to evaluate a quality of the text based on a grammatical correctness, diversity of vocabulary, fluency, readability, length, and structure of the text. The instruction data can indicate a score of each image-text pair for each of the plurality of image-text pair quality scoring tasks.

The instruction data generated by teacher model may not be uniformly distributed on the score scale of 100. At 704, a balanced instruction dataset (e.g., balanced instruction data 404) can be generated. The balanced instruction dataset can be generated by sampling the instruction data. The balanced instruction dataset can include image-text pairs with diverse quality levels. To sample the instruction data into the balanced instruction dataset, the instruction data can be grouped into ten buckets and 100 instructions can be uniformly sampled from each bucket. The score distribution of the balanced instruction dataset can be more diverse and uniform than the original score distribution of the instruction data. The balanced instruction dataset for all three metrics can be combined into a single balanced instruction data set.

At 706, a mixed instruction dataset (e.g., mixed instruction data 408) can be generated. The mixed instruction dataset can be generated by mixing (e.g., combining) the balanced instruction dataset with other instruction datasets (e.g., additional instruction data 406) corresponding to other vision-language tasks. The other vision-language tasks can include captioning, OCR, visual question-answering, etc. At 708, a machine learning model (e.g., the machine learning model 111) can be fine-tuned using the mixed instruction dataset.

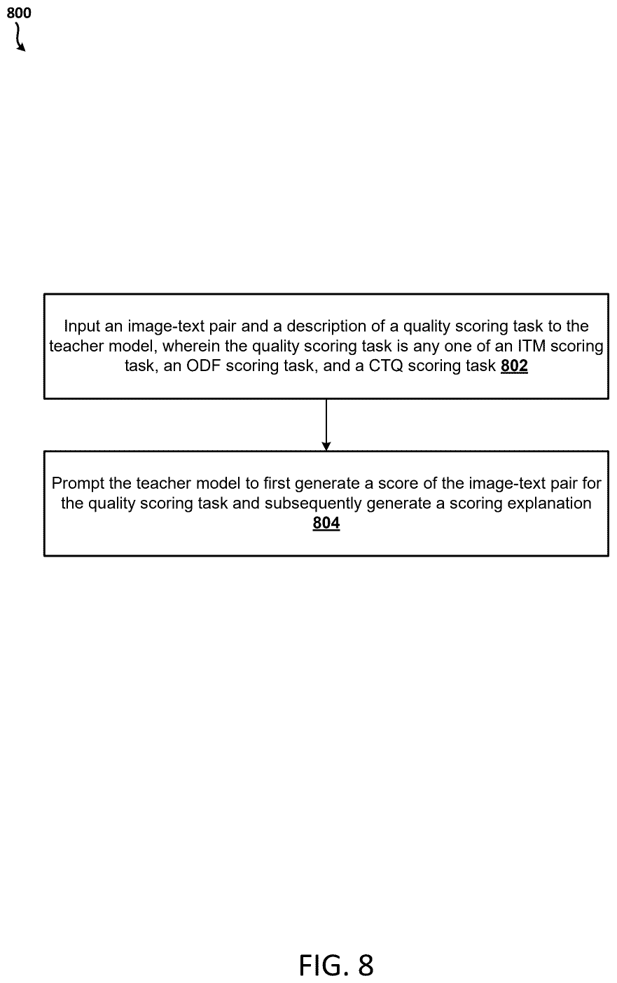

FIG. 8 shows an example process 800 for generating instruction data. Although depicted as a sequence of operations in FIG. 8, those of ordinary skill in the art will appreciate that various embodiments may add, remove, reorder, or modify the depicted operations.

At 802, an image-text pair and a description of a quality scoring task can be input to a teacher model (e.g., the teacher model 202). The quality scoring task is any one of an ITM scoring task, an ODF scoring task, and a CTQ scoring task. The ITM scoring task can be configured to evaluate whether a text in an image-text pair accurately represents primary features of an image in the image-text pair. The ODF scoring task can be configured to evaluate whether the text depicts detailed properties of objects in the image. The CTQ scoring task can be configured to evaluate a quality of the text based on a grammatical correctness, diversity of vocabulary, fluency, readability, length, and structure of the text.

At 804, the teacher model can be prompted to first generate a score of the image-text pair for the quality scoring task and subsequently generate a scoring explanation. For example, a prompt (e.g., prompt 201) input into the teacher model can include the following instruction (or a similar instruction): “Please first output a single line containing the value indicating the scores. In the subsequent line, please provide a comprehensive explanation of your evaluation, avoiding any potential bias.” This process can be repeated for each of the three quality scoring tasks. For example, the teacher model can be prompted to generate a score of the image-text pair for the ITM scoring task and subsequently generate a scoring explanation for the ITM scoring task. The teacher model can be further prompted to generate a score of the image-text pair for the ODF scoring task and subsequently generate a scoring explanation for the ODF scoring task. Finally, the teacher model can be further prompted to generate a score of the image-text pair for the CTQ scoring task and subsequently generate a scoring explanation for the CTQ scoring task.

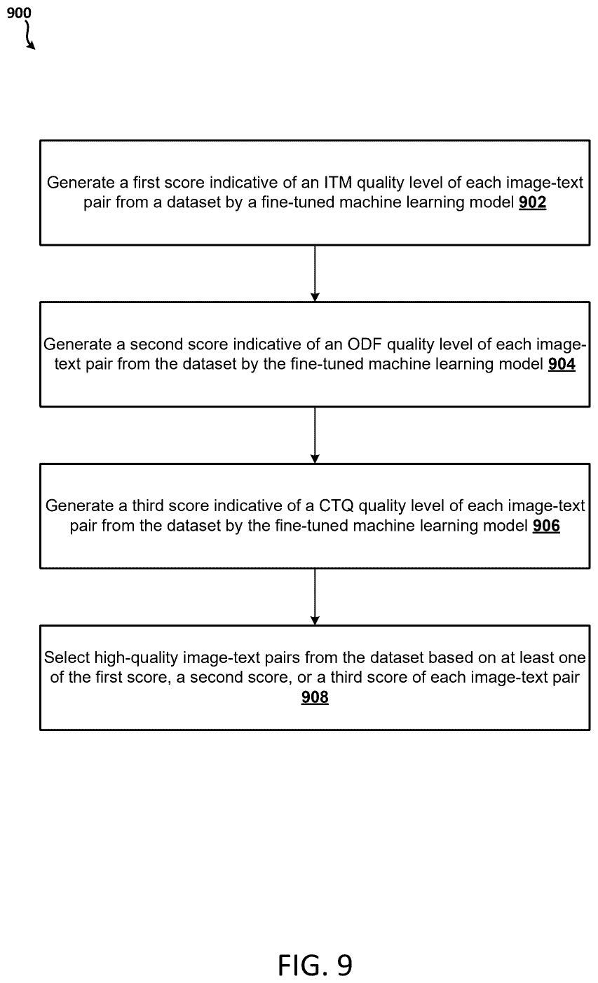

FIG. 9 shows an example process 900 for filtering image-text data. Although depicted as a sequence of operations in FIG. 9, those of ordinary skill in the art will appreciate that various embodiments may add, remove, reorder, or modify the depicted operations.

At 902, a first score can be generated. The first score can be indicative of an Image-Text Matching (ITM) quality level of each image-text pair from a dataset (e.g., dataset 109). The first score can be generated by a fine-tuned machine learning model (e.g., fine-tuned machine learning model 112). The first score can indicate whether a text in an image-text pair accurately represents primary features of an image in the image-text pair. A high first score indicates that the text in the image-text pair accurately represents primary features of the image in the image-text pair, while a low first score indicates that the text in the image-text pair does not accurately represent primary features of the image in the image-text pair.

At 904, a second score can be generated. The second score can be indicative of an Object Detail Fulfillment (ODF) quality level of each image-text pair from the dataset. The second score can be generated by the fine-tuned machine learning model. The second score can indicate whether the text depicts detailed properties of objects in the image. A high second score indicates that the text depicts detailed properties of objects in the image, while a low second score indicates that the text does not depict detailed properties of objects in the image.

At 906, a third score can be generated. The third score can be indicative of a Caption Text Quality (CTQ) quality level of each image-text pair from the dataset. The third score can be generated by the fine-tuned machine learning model. The third score can indicate a quality of the text based on a grammatical correctness, diversity of vocabulary, fluency, readability, length, and structure of the text. A high third score indicates that the text is high quality, while a low third score indicates that the text is low quality.

At 908, high-quality image-text pairs (e.g., filtered high-quality image-text dataset 240) can be selected from the dataset. The high-quality image-text pairs can be selected from the dataset based on at least one of the first score, a second score, or a third score of each image-text pair. Selecting high-quality image-text pairs from the dataset based on one or more of the plurality of metrics can include selecting the image-text pairs having the highest scores. For example, selecting high-quality image-text pairs from the dataset can include selecting image-text pairs having at least one of a first score, a second score, or a third score that satisfies (e.g., exceeds) a threshold. Alternatively, selecting high-quality image-text pairs from the dataset can include selecting image-text pairs associated with a combined score (e.g., a combination of two or more of the first score, the second score, or the third score) that satisfies (e.g., exceeds) a threshold.

To create an optimal fine-tuned MLM data filter, comprehensive ablation studies were conducted to investigate the effects of different design choices on the filtering performance. Four major design choices for constructing the instruction data for scoring tasks were investigated. First, it was investigated whether mixing the scoring task instruction data with the additional instruction data is effective for multi-task instruction tuning. Second, experiments were conducted using two different image-text datasets (e.g., CC12M and DataComp Medium 128M) for constructing visual instructions. Third, the effectiveness of rebalancing the score distribution of the original instruction data was evaluated. Fourth, experiments were conducted with CLIP image encoders of different input image resolutions of 224 pixels and 336 pixels. The DataComp benchmark was used to evaluate the effectiveness of different data filtering hyperparameters.

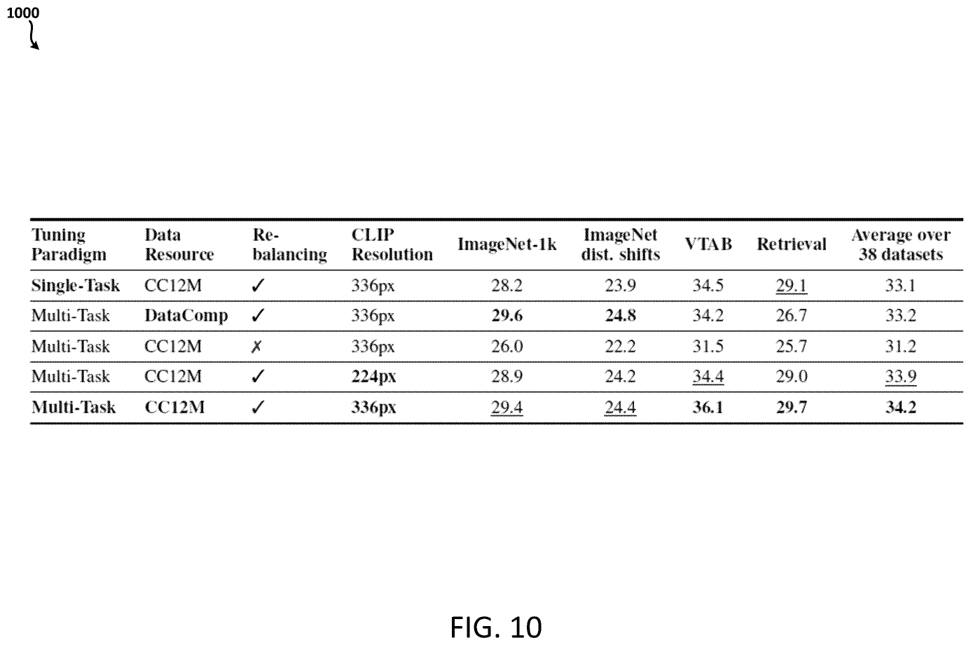

To investigate the effects of each design choice, the selection of the other three design choices were kept constant and only one design choice was changed for each experiment group. While three different metrics to assess data quality are described herein, to investigate the effects of each design choice, only the metric of Image-Text-Matching (ITM) was used as the filtering metric to select a high-quality subset from the 128M medium scale data pool. The ablation results for all four design choices are presented in the table 1000 of FIG. 10.

As shown in in the first and last rows of the table 1000, mixing the instruction data generated by the teacher model 202 with the additional data and performing multi-task visual instruction tuning leads to better filtering performance. The reasoning capability of MLMs can be strengthened via learning the transferring knowledge from other tasks. Next, the table 1000 shows that adopting CC12M to sample image-text pairs for data construction outperforms the design choice of using the DataComp-Medium dataset. The instruction data constructed from DataComp contains a set of simple and noisy captioning text patterns (e.g., “*.jpg”), which are easy to be filtered by rules and heuristics. Such noisy instruction data may enable the fine-tuned machine learning model 112 to only learn to capture the shallow text patterns for filtering low-quality data rather than effectively infer the quality scores. Thirdly, the table 1000 shows that rebalancing the instruction data based on score buckets can help the fine-tuned machine learning model 112 to avoid learning scoring bias. In terms of the input image resolution, adopting a larger resolution leads to better filtering performance while it also introduces more image patch feature tokens for representing an image. Therefore, the four settings presented in the last row of the table 1000, which yield the best performance, are fixed as the design choices for constructing the fine-tuned machine learning model 112.

The effectiveness of adopting fine-tuned MLMs as high-quality image-text data filters was evaluated. The performance of vision-language models pre-trained on datasets filtered using a baseline filter was compared with the performance of vision-language models pre-trained on datasets filtered using the MLM filter described herein. Two different VLM architectures were selected for comprehensive evaluation: CLIP pre-training and BLIP-2 pre-training. Additionally, human evaluation was conducted to compute the correlation between the scoring generated by the fine-tuned machine learning model 112 and the baseline CLIP model.

The fine-tuned machine learning model 112 was compared with other filtering methods from Data-Comp, including applying no filtering, basic filtering, LAION filtering and CLIPScore filtering. The basic filtering method adopts three rule-based filters, filtering English only, filtering by caption length, and filtering by image size. The text-based filtering selects English captions that contain words from ImageNet-21K or ImageNet-1K class synsets. The LAION filtering adopts both the CLIPScore filtering using ViT-B/32 CLIP model and the English filtering. The CLIPScore filtering utilizes a larger ViT-L/14 CLIP model for score generation and data filtering. The computational budget and hyperparameters were fixed for pre-training CLIP using different filters. The CLIP model architecture was determined by the data scale, in which the ViT-B/32 model was pre-trained on the medium scale setting and ViT-B/16 model is on the large scale setting.

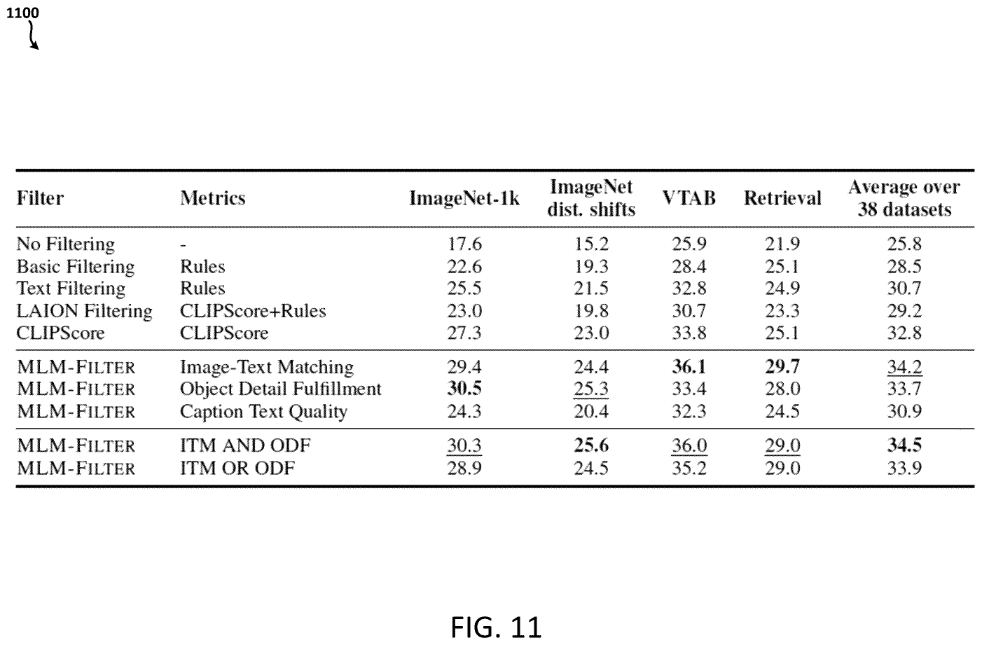

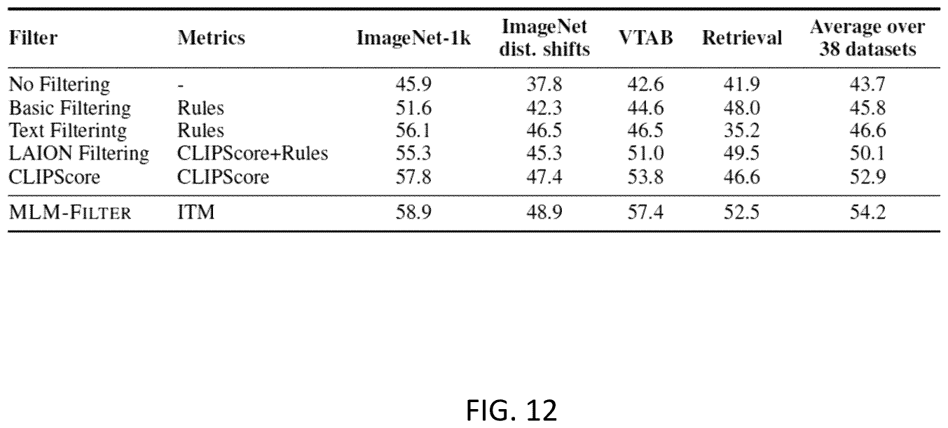

The DataComp results between the fine-tuned machine learning model 112 and other baselines are presented in the table 1100 of FIG. 11 and the table 1200 of FIG. 12 for medium and large scale, respectively. As shown in the table 1100, on the medium-scale DataComp benchmark, the fine-tuned machine learning model 112 significantly outperforms the CLIPScore baseline on different task subgroups, achieving notable improvements of +3.2 accuracy on ImageNet-1k, +2.6 average accuracy on 6 ImageNet shifted datasets, +2.3 average accuracy on 13 VTAB datasets, and +4.6 average scores on 3 retrieval datasets. Further, as shown in the table 1100 and the table 1200, the fine-tuned machine learning model 112 surpasses CLIPScore baseline by +1.7 and +1.3 on the average scores over 38 datasets on DataComp Medium and Large Scale benchmarks, which demonstrates that the fine-tuned machine learning model 112 can work as more effective filtering method than CLIPScore filter.

In embodiments, combining different quality metrics can effectively filter and identify image-text pairs of better quality. The AND operation (e.g., to combine ITM and ODF quality metrics) means that the ITM and ODF score of selected datapoints should exceed the filtering thresholds of both metrics, while the OR operation to combine two metrics means that the selected datapoints should either exceed the threshold for ITM metric or that for ODF metric. In embodiments, the combination of ITM and ODF metrics using AND operation outperforms all the baseline filtering methods and other variants of the fine-tuned machine learning model 112, achieving the best average performance of 34.5 over 38 datasets.

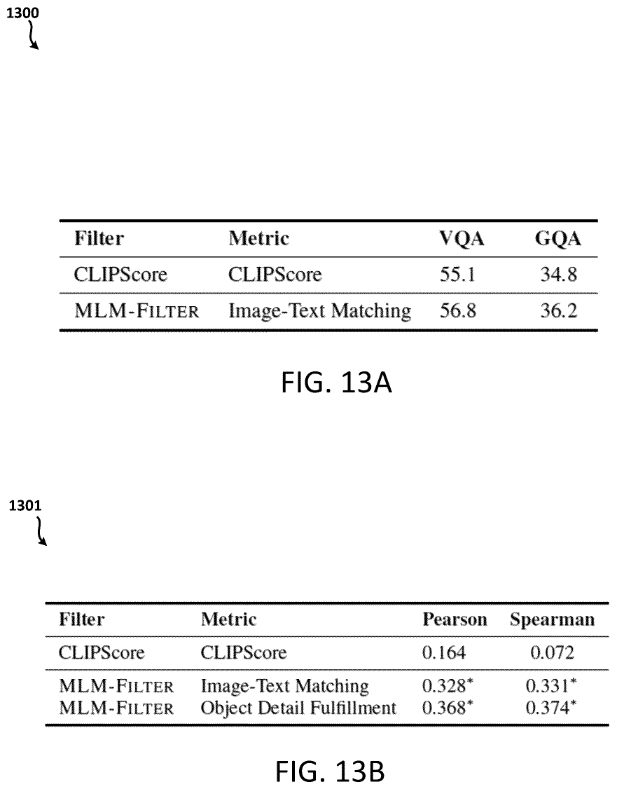

Two BLIP-2 models pre-trained on different filtered datasets were evaluated on VQAv2 and GQA datasets in a zero-shot manner and the results of zero-shot VQA performance are shown in the table 1300 of FIG. 13A. The BLIP-2 pre-trained with the image-text data filtered by the fine-tuned machine learning model 112 achieves +1.7 and +1.4 improvements on VQAv2 and GQA datasets as compared to the BLIP-2 pre-trained on a CLIPSCore filtered dataset.

The correlation between human scoring and model scoring was computed to evaluate the alignment between human filtering and the filtering model. A set of 100 image-text pairs were sampled from CC12M and MSCOCO and labeled with human scores in terms of the image-text matching. CLIPScore and the fine-tuned machine learning model 112 were used to generate the image-text matching scores for the selected image-text pairs. Then, the Pearson and Spearman scores are reported between the human scores and model scores, as presented in the table 1301 of FIG. 13B. The scores generated by the fine-tuned machine learning model 112 are significantly aligned and correlated with human quality scores, while CLIPScore does not demonstrate such correlations. The two quality metrics Image-Text Matching and Object Detail Fulfillment both demonstrate significant correlations with human quality scores.

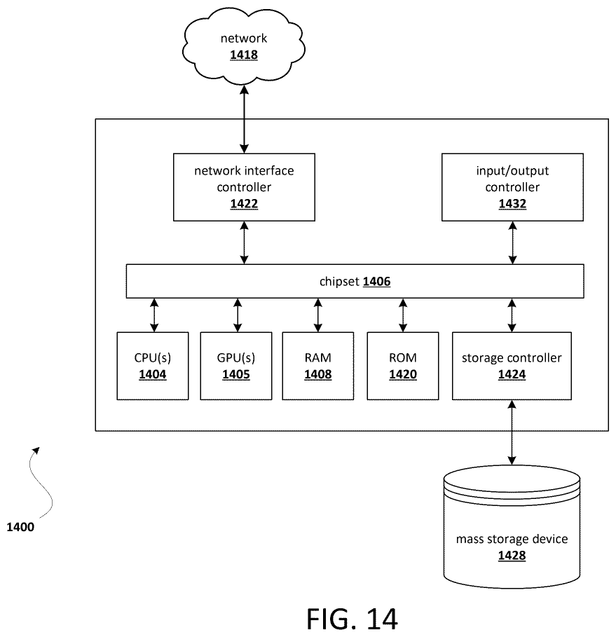

FIG. 14 illustrates a computing device that may be used in various aspects, such as the services, networks, modules, and/or devices depicted in any of FIGS. 1-4. With regard to FIGS. 1-4, any or all of the components may each be implemented by one or more instance of a computing device 1400 of FIG. 14. The computer architecture shown in FIG. 14 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1400 may include a baseboard, or “motherboard,” which is a printed circuit board to which a multitude of components or devices may be connected by way of a system bus or other electrical communication paths. One or more central processing units (CPUs) 1404 may operate in conjunction with a chipset 1406. The CPU(s) 1404 may be standard programmable processors that perform arithmetic and logical operations necessary for the operation of the computing device 1400.

The CPU(s) 1404 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1404 may be augmented with or replaced by other processing units, such as GPU(s) 1405. The GPU(s) 1405 may comprise processing units specialized for but not necessarily limited to highly parallel computations, such as graphics and other visualization-related processing.

A chipset 1406 may provide an interface between the CPU(s) 1404 and the remainder of the components and devices on the baseboard. The chipset 1406 may provide an interface to a random-access memory (RAM) 1408 used as the main memory in the computing device 1400. The chipset 1406 may further provide an interface to a computer-readable storage medium, such as a read-only memory (ROM) 1420 or non-volatile RAM (NVRAM) (not shown), for storing basic routines that may help to start up the computing device 1400 and to transfer information between the various components and devices. ROM 1420 or NVRAM may also store other software components necessary for the operation of the computing device 1400 in accordance with the aspects described herein.

The computing device 1400 may operate in a networked environment using logical connections to remote computing nodes and computer systems through local area network (LAN). The chipset 1406 may include functionality for providing network connectivity through a network interface controller (NIC) 1422, such as a gigabit Ethernet adapter. A NIC 1422 may be capable of connecting the computing device 1400 to other computing nodes over a network 1416. It should be appreciated that multiple NICs 1422 may be present in the computing device 1400, connecting the computing device to other types of networks and remote computer systems.

The computing device 1400 may be connected to a mass storage device 1428 that provides non-volatile storage for the computer. The mass storage device 1428 may store system programs, application programs, other program modules, and data, which have been described in greater detail herein. The mass storage device 1428 may be connected to the computing device 1400 through a storage controller 1424 connected to the chipset 1406. The mass storage device 1428 may consist of one or more physical storage units. The mass storage device 1428 may comprise a management component. A storage controller 1424 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1400 may store data on the mass storage device 1428 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1428 is characterized as primary or secondary storage and the like.

For example, the computing device 1400 may store information to the mass storage device 1428 by issuing instructions through a storage controller 1424 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1400 may further read information from the mass storage device 1428 by detecting the physical states or characteristics of one or more particular locations within the physical storage units.

In addition to the mass storage device 1428 described above, the computing device 1400 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1400.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1428 depicted in FIG. 14, may store an operating system utilized to control the operation of the computing device 1400. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1428 may store other system or application programs and data utilized by the computing device 1400.

The mass storage device 1428 or other computer-readable storage media may also be encoded with computer-executable instructions, which, when loaded into the computing device 1400, transforms the computing device from a general-purpose computing system into a special-purpose computer capable of implementing the aspects described herein. These computer-executable instructions transform the computing device 1400 by specifying how the CPU(s) 1404 transition between states, as described above. The computing device 1400 may have access to computer-readable storage media storing computer-executable instructions, which, when executed by the computing device 1400, may perform the methods described herein.

A computing device, such as the computing device 1400 depicted in FIG. 14, may also include an input/output controller 1432 for receiving and processing input from a number of input devices, such as a keyboard, a mouse, a touchpad, a touch screen, an electronic stylus, or other type of input device. Similarly, an input/output controller 1432 may provide output to a display, such as a computer monitor, a flat-panel display, a digital projector, a printer, a plotter, or other type of output device. It will be appreciated that the computing device 1400 may not include all of the components shown in FIG. 14, may include other components that are not explicitly shown in FIG. 14, or may utilize an architecture completely different than that shown in FIG. 14.

As described herein, a computing device may be a physical computing device, such as the computing device 1400 of FIG. 14. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method of filtering image-text data, comprising:
constructing instruction data on a plurality of image-text pair quality scoring tasks;
fine-tuning a machine learning model to an image-text data filter using the constructed instruction data;
evaluating a quality of each image-text pair from a dataset by the fine-tuned machine learning model using a plurality of metrics, wherein the plurality of metrics comprise an Image-Text Matching (ITM) metric, an Object Detail Fulfillment (ODF) metric, and a Caption Text Quality (CTQ) metric; and
selecting high-quality image-text pairs from the dataset based on one or more of the plurality of metrics.

2. The method of claim 1, further comprising:
training another machine learning model on the selected high-quality image-text pairs to improve a performance of the other machine learning model.

3. The method of claim 1, further comprising:
constructing the instruction data on the plurality of image-text pair quality scoring tasks using a teacher model, wherein the plurality of image-text pair quality scoring tasks comprise an ITM scoring task, an ODF scoring task, and a CTQ scoring task.

4. The method of claim 3, further comprising:
inputting an image-text pair and a description of a quality scoring task to the teacher model, wherein the quality scoring task is any of the plurality of image-text pair quality scoring tasks; and
prompting the teacher model to first generate a score of the image-text pair for the quality scoring task and subsequently generate a scoring explanation.

5. The method of claim 1, further comprising:
generating a balanced instruction dataset by sampling the instruction data, wherein the balanced instruction dataset comprises image-text pairs with diverse quality levels;
generating a mixed instruction dataset by mixing the balanced instruction dataset with other instruction datasets corresponding to other vision-language tasks; and
fine-tuning the machine learning model using the mixed instruction dataset.

6. The method of claim 1, wherein the ITM metric is configured to evaluate whether a text in an image-text pair accurately represents primary features of an image in the image-text pair, wherein the ODF metric is configured to evaluate whether the text depicts detailed properties of objects in the image, and wherein the CTQ is configured to evaluate a quality of the text based on a grammatical correctness, diversity of vocabulary, fluency, readability, length, and structure of the text.

7. The method of claim 1, wherein the evaluating a quality of each image-text pair from a dataset by the fine-tuned machine learning model comprises:
generating a first score indicative of an ITM quality level of each image-text pair;
generating a second score indicative of an ODF quality level of each image-text pair; and
generating a third score indicative of a CTQ quality level of each image-text pair.

8. The method of claim 1, wherein the selecting high-quality image-text pairs from the dataset based on one or more of the plurality of metrics comprises:
selecting the high-quality image-text pairs from the dataset based on at least one of the first score, a second score, or a third score of each image-text pair.

9. A system, comprising:
at least one processor; and
at least one memory communicatively coupled to the at least one processor and comprising computer-readable instructions that upon execution by the at least one processor cause the at least one processor to perform operations comprising:
constructing instruction data on a plurality of image-text pair quality scoring tasks;
fine-tuning a machine learning model to an image-text data filter using the constructed instruction data;
evaluating a quality of each image-text pair from a dataset by the fine-tuned machine learning model using a plurality of metrics, wherein the plurality of metrics comprise an Image-Text Matching (ITM) metric, an Object Detail Fulfillment (ODF) metric, and a Caption Text Quality (CTQ) metric; and
selecting high-quality image-text pairs from the dataset based on one or more of the plurality of metrics.

10. The system of claim 9, the operations further comprising:
training another machine learning model on the selected high-quality image-text pairs to improve a performance of the other machine learning model.

11. The system of claim 9, the operations further comprising:
constructing the instruction data on the plurality of image-text pair quality scoring tasks using a teacher model, wherein the plurality of image-text pair quality scoring tasks comprise an ITM scoring task, an ODF scoring task, and a CTQ scoring task.

12. The system of claim 11, the operations further comprising:
inputting an image-text pair and a description of a quality scoring task to the teacher model, wherein the quality scoring task is any of the plurality of image-text pair quality scoring tasks; and
prompting the teacher model to first generate a score of the image-text pair for the quality scoring task and subsequently generate a scoring explanation.

13. The system of claim 9, the operations further comprising:
generating a balanced instruction dataset by sampling the instruction data, wherein the balanced instruction dataset comprises image-text pairs with diverse quality levels;
generating a mixed instruction dataset by mixing the balanced instruction dataset with other instruction datasets corresponding to other vision-language tasks; and
fine-tuning the machine learning model using the mixed instruction dataset.

14. The system of claim 9, wherein the evaluating a quality of each image-text pair from a dataset by the fine-tuned machine learning model comprises:
generating a first score indicative of an ITM quality level of each image-text pair;
generating a second score indicative of an ODF quality level of each image-text pair; and
generating a third score indicative of a CTQ quality level of each image-text pair.

15. A non-transitory computer-readable storage medium, storing computer-readable instructions that upon execution by a processor cause the processor to implement operations comprising:
constructing instruction data on a plurality of image-text pair quality scoring tasks;
fine-tuning a machine learning model to an image-text data filter using the constructed instruction data;
evaluating a quality of each image-text pair from a dataset by the fine-tuned machine learning model using a plurality of metrics, wherein the plurality of metrics comprise an Image-Text Matching (ITM) metric, an Object Detail Fulfillment (ODF) metric, and a Caption Text Quality (CTQ) metric; and
selecting high-quality image-text pairs from the dataset based on one or more of the plurality of metrics.

16. The non-transitory computer-readable storage medium of claim 15, the operations further comprising:
training another machine learning model on the selected high-quality image-text pairs to improve a performance of the other machine learning model.

17. The non-transitory computer-readable storage medium of claim 15, the operations further comprising:
constructing the instruction data on the plurality of image-text pair quality scoring tasks using a teacher model, wherein the plurality of image-text pair quality scoring tasks comprise an ITM scoring task, an ODF scoring task, and a CTQ scoring task.

18. The non-transitory computer-readable storage medium of claim 17, the operations further comprising:
inputting an image-text pair and a description of a quality scoring task to the teacher model, wherein the quality scoring task is any of the plurality of image-text pair quality scoring tasks; and
prompting the teacher model to first generate a score of the image-text pair for the quality scoring task and subsequently generate a scoring explanation.

19. The non-transitory computer-readable storage medium of claim 15, the operations further comprising:
generating a balanced instruction dataset by sampling the instruction data, wherein the balanced instruction dataset comprises image-text pairs with diverse quality levels;
generating a mixed instruction dataset by mixing the balanced instruction dataset with other instruction datasets corresponding to other vision-language tasks; and
fine-tuning the machine learning model using the mixed instruction dataset.

20. The non-transitory computer-readable storage medium of claim 15, wherein the evaluating a quality of each image-text pair from a dataset by the fine-tuned machine learning model comprises:
generating a first score indicative of an ITM quality level of each image-text pair;
generating a second score indicative of an ODF quality level of each image-text pair; and
generating a third score indicative of a CTQ quality level of each image-text pair.
